(19) United States
(12) Patent Application Publication
(10) Pub. No.: US 2010/0171351 A1
(43) Pub. Date: Jul. 8, 2010

(54) FITTING FOR A VEHICLE SEAT

(75) Inventors: Peter Thiel, Remscheid (DE); Andreas Vedder, Haan (DE)

Correspondence Address: MCGLEW & TUTTLE, PC, P.O. BOX 9227, SCARBOROUGH STATION, SCARBOROUGH, NY, 10510-9227, US

(73) Assignee: KEIPER GMBH & CO. KG, Kaiserslautern (DE)

(21) Appl. No.: 12/160,841

(22) PCT Filed: Dec. 19, 2006
(86) PCT No.: PCT/EP2006/012208

§ 371 Date: Jul. 14, 2008

(30) Foreign Application Priority Data
Jan. 24, 2006 (DE) 10 2006 003 241.1
Jan. 24, 2006 (DE) 10 2006 003 243.8
Jan. 24, 2006 (DE) 20 2006 013 783.1
Sep. 21, 2006 (DE) 10 2006 044 489.2
Oct. 17, 2006 (DE) 20 2006 015 871.5

(51) Int. Cl. B60N 2/12; B60N 2/235; B60N 2/20

(52) U.S. Cl. 297/341; 297/367 R

(57) ABSTRACT

A fitting (205) for a vehicle seat, in particular for a motor vehicle seat, is provided with a first fitting part (209) fixed on the seat part, a second fitting part (211) which is rotatable relative to the first fitting part (209) and is intended for adjusting the inclination of the backrest (202) of the vehicle seat (201) between a plurality of use positions and a third fitting part (124) which is fixed on the backrest. The third fitting part (124) is lockable with the second fitting part (211) and is provided for central, free-pivoting of the backrest (202). The third fitting part (124) is pivotable relative to the second fitting part (211) about an axis (A) and is securable in the freely pivoted position of the backrest (202). At least one latch or pawl (220) is provided for locking and/or securing, wherein the same latch or pawl (220) is used to lock the third fitting part (214) in the use positions of the backrest (202) and to secure it in the freely pivoted position of the backrest (202).

### CROSS REFERENCE TO RELATED APPLICATIONS

This application is a United States National Phase application of International Application PCT/EP2004/008104 filed Jul. 20, 2004 and claims the benefit of priority under 35 U.S.C. §119 of German Patent Application DE 103 33 456.4 filed Jul. 22, 2003, the entire contents of which are incorporated herein by reference.

### FIELD OF THE INVENTION

The invention relates to a fitting for a vehicle seat, in particular for a motor vehicle seat, having a first fitting part fixed with respect to the seat part, with a second fitting part rotatable in relation to the first fitting part, for setting the inclination of the backrest of the vehicle seat between a plurality of positions of use, with a third fitting part which is fixed with the respect to the backrest, can be interlocked with second fitting part and can be pivoted about an axis in relation to the second fitting part for a centric free pivoting of the backrest and which can be secured in the freely pivoted position of the backrest, and with at least one pawl for locking or securing.

### BACKGROUND OF THE INVENTION

DE 102 06 303 A1 discloses a fitting of this type for a two-door motor vehicle, which fitting serves for allowing access to the rear seats by virtue of the free forward pivoting of the backrest and for making available various backrest inclination settings for use by an occupant. For the free pivoting of the backrest, the fitting is unlocked as a result of the pivoting of an unlocking pin in a slotted link, soiling of the locking mechanism being avoided by means of a cover of this slotted link. In order to prevent an unwanted reverse pivoting of the backrest, for example in the case of excessive upholstery in the transitional region between the backrest and the seat part, a securing of the backrest is provided in the freely pivoted position.

### SUMMARY OF THE INVENTION

The object on which the invention is based is to improve a fitting of the type initially mentioned.

According to the invention, a fitting is provided for a vehicle seat of a vehicle such as a motor vehicle. The vehicle seat comprises a seat part, a backrest mounted to the seat part with an adjustable inclination of the backrest relative to the seat part. The backrest is also mounted to the seat part for freely pivoting motion relative to the seat part. A longitudinal adjuster is provided wherein the seat part is movable forward during the free pivoting motion of the backrest. The fitting comprises a first fitting part fixed with respect to the seat part and a second fitting part rotatable in relation to the first fitting part. The second fitting part is for adjusting the inclination of the backrest relative to the seat part and setting the inclination of the backrest between a plurality of use positions. A third fitting part is fixed with respect to the backrest. The third fitting part is interlockable with the second fitting part and is pivotable about an axis in relation to the second fitting part for a centric pivoting and for the free pivoting of the backrest. The third fitting part is securable in the freely pivoted position of the backrest. A pawl is provided for locking the third fitting part in any of the positions of use of the backrest and for securing the third fitting part in the freely pivoted position of the backrest.

Since the same pawl both locks the third fitting part in the positions of use of the backrest and secures the third fitting part in the freely pivoted position of the backrest, both the number of components and the required construction space are reduced, as compared with the known fitting. In order to carry out securing in the freely pivoted position independently of the set inclination of the backrest, preferably separate components for cooperation with the pawl are provided, in particular a securing ring, preferably mounted on the second fitting part and retained by the first fitting part or tensioned against the latter, and a latching element connected fixedly to the second fitting part, which components, however, have in each case, for direct cooperation with the pawl, a boss or a step or the like in their respective plane or in a common plane. In the case of an arrangement in various planes, the pawl has, preferably for each of the two planes, a specific region for cooperation, for example a tooth or finger.

For locking the third fitting part in the positions of use, the pawl bears preferably with prestress against a latching stop of the latching element. The pawl is preferably mounted pivotably on the third fitting part by means of a bearing bolt designed as an eccentric bolt. The bearing bolt can preferably be set and fixed such as to ensure maximum pawl engagement.

To secure the third fitting part in the freely pivoted position, the pawl, during cooperation with the securing ring, preferably engages behind a securing boss of the securing ring. For cooperation (interaction) with the securing ring the pawl drops behind the securing boss, preferably in a radially inward direction and, when cooperation (interaction) is canceled, the pawl is lifted out, preferably in a radially outward direction.

Pivotable pins, rotatable switching rings or a rotatable unlocking shaft can again lift out the pawl or its securing elements. Since an unlocking shaft is provided, of which the rotation about its own axis unlocks the pawl, a relatively dirt-free space is provided in a simple way within the fitting. A cover, such as is required in the case of a pivotable pin for the assigned slotted link, is dispensed with by means of such a solution. The pawl can be lifted out directly by means of the unlocking shaft. Preferably, however, for freeing the play of the pawl, a tension piece is present as a securing element, and, to reinforce load absorption in the event of a crash, a special catching piece is preferably provided as a further securing element for supporting the pawl. The unlocking shaft then pivots at least one of these two elements away from the pawl. The other element is preferably coupled for take-up with idle travel, such other end is ultimately also pivoted by the rotating unlocking shaft away from the pawl, so that the pawl is unlocked.

To reinforce load absorption in the event of a crash, a special catching pawl for support on the latching element may be provided additionally or alternatively. The catching pawl, which is mounted pivotably on the third fitting part, for example by means of a bearing bolt, comes in the event of a crash preferably to bear against a stop of the latching element, without an opening moment being exerted by the latching element on the catching pawl. The pawl for locking and securing the third fitting part can then be mounted pivotably on the catching pawl or the bearing bolt of the catching pawl. Preferably, a common spring prestresses both the catching pawl and the pawl for locking and securing the third fitting part into the closing direction. The pawl for locking and securing the third fitting part and the catching pawl are preferably coupled by means of a mortise-and-tenon guide.

A switching ring is provided that is rotatable in relation to the securing ring. During a relative rotation of the securing ring and switching ring, the cooperation of the pawl and of the securing ring is canceled. The securing of the backrest, taking place by means of the fitting, can be terminated automatically in the presence of specific conditions, for example a specific longitudinal position of the seat, so that the backrest can then be pivoted in reverse into its initial position. Preferably, the relative rotation of the securing ring and switching ring lifts out the pawl preferably dropping in the radial direction, for which purpose the switching ring preferably has a switching cam with a radially expanding flank Suitable arrangements and prestresses (spring biases) of the components ensure a rattle-free bearing contact of the components. There are preferably several possibilities for activating the pawl, the securing ring and/or the switching ring.

Preferably, before engaging behind the securing boss, the pawl rotates the switching ring through a small angle, and the switching ring rotates in reverse due to a prestress when the pawl engages behind the securing boss. Preferably, either the securing ring or the switching ring are retained in relation to the first fitting part with play by means of a blocking stop projecting axially in relation to the first fitting part. Two blocking fingers projecting radially from the retained ring receive the blocking stop between them. The ring, of the two rings, which is not retained is preferably prestressed in a direction toward the blocking stop.

The ring prestressed toward the blocking stop boss may be acted upon by a pivotably mounted blocking lever. This lever is outside self-locking, bears against a stop boss of the ring. Preferably, a pivotably mounted and prestressed tension lever acts upon the blocking lever. A tension contour of one lever bears against a blocking pin of the other lever, without the blocking lever exerting an opening moment on the tension lever.

The invention can be used preferably on longitudinally adjustable vehicle seats of two-door motor vehicles with a centric free pivoting of the backrest, but may also be employed for other vehicle seats. In a use of the fitting according to the invention for activating what is known as the “easy-entry function”, in which, in addition to a free pivoting of the backrest, a movement of the vehicle seat also takes place, the reverse pivoting of the backrest may take place exactly when the preset longitudinal position of the seat is reached.

The invention is explained in more detail below by means of several exemplary embodiments having modifications and illustrated in the drawing. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an exploded perspective illustration of the first exemplary embodiment without cable pulls, in which the components illustrated on the far right are shown in a different perspective angle from the components illustrated on the far left;

FIG. 2 is a diagrammatic side view of a vehicle seat with features according to the invention;

FIG. 3 is a front view of parts of the first exemplary embodiment which are relevant for free pivoting, in the position of use of the backrest;

FIG. 4 is a sectional view taken along the line IV-IV in FIG. 3;

FIG. 5 is a sectional view taken along the line V-V in FIG. 3;

FIG. 6 is a partial view of parts of FIG. 3 without a tension piece;

FIG. 7 is a front view corresponding to FIG. 3 in the freely pivoted position of the backrest;

FIG. 8 is a view of the rear side of the pawl;

FIG. 9 is a perspective part view of the first exemplary embodiment in the freely pivoted position of the backrest with a view of the rear side of the pawl;

FIG. 10 is a view showing a modification of the catching piece;

FIG. 11 is a view showing a modification of the first exemplary embodiment;

FIG. 12 is a view showing an addition to the first exemplary embodiment;

FIG. 13 is an exploded perspective illustration of the second exemplary embodiment without cable pulls, in which the components illustrated on the far right are shown in a different perspective angle from the components illustrated on the far left;

FIG. 14 is a sectional view through the second exemplary embodiment which is in a position of use, in a plane perpendicular to the axis;

FIG. 15 is an illustration corresponding to FIG. 14 in the freely pivoted position;

FIG. 16 is an illustration corresponding to FIG. 14 during unlocking by means of the longitudinal adjuster;

FIG. 17 is a sectional view through the second exemplary embodiment which is in a position of use, in a plane along the axis;

FIG. 18 is an exploded perspective illustration of the third exemplary embodiment according to the invention without cable pulls, in which the components illustrated on the far right are shown in a different perspective angle from the components illustrated on the far left;

FIG. 19 is a sectional view through the third exemplary embodiment which is in a position of use, in a plane perpendicular to the axis;

FIG. 20 is an illustration corresponding to FIG. 19 in the freely pivoted position;

FIG. 21 is an illustration corresponding to FIG. 19 during unlocking by means of the longitudinal adjuster;

FIG. 22 is a sectional view through the third exemplary embodiment which is in a position of use, in a plane along the axis; and

FIG. 23 is a diagrammatic side view of a vehicle seat with features according to the invention.

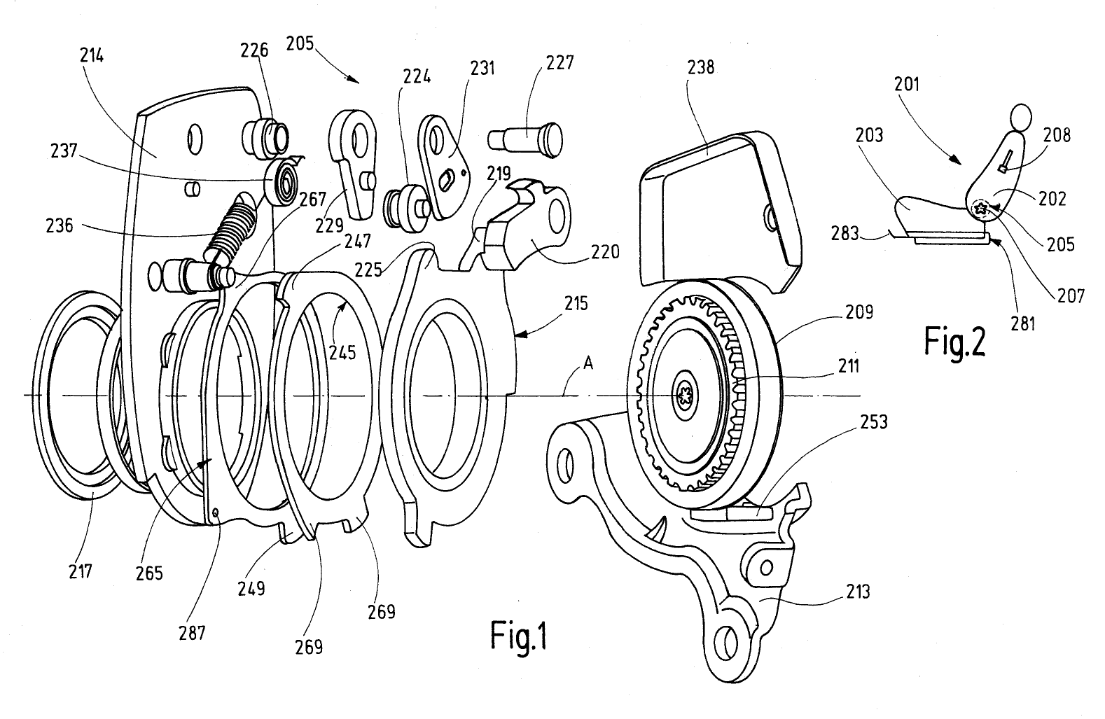

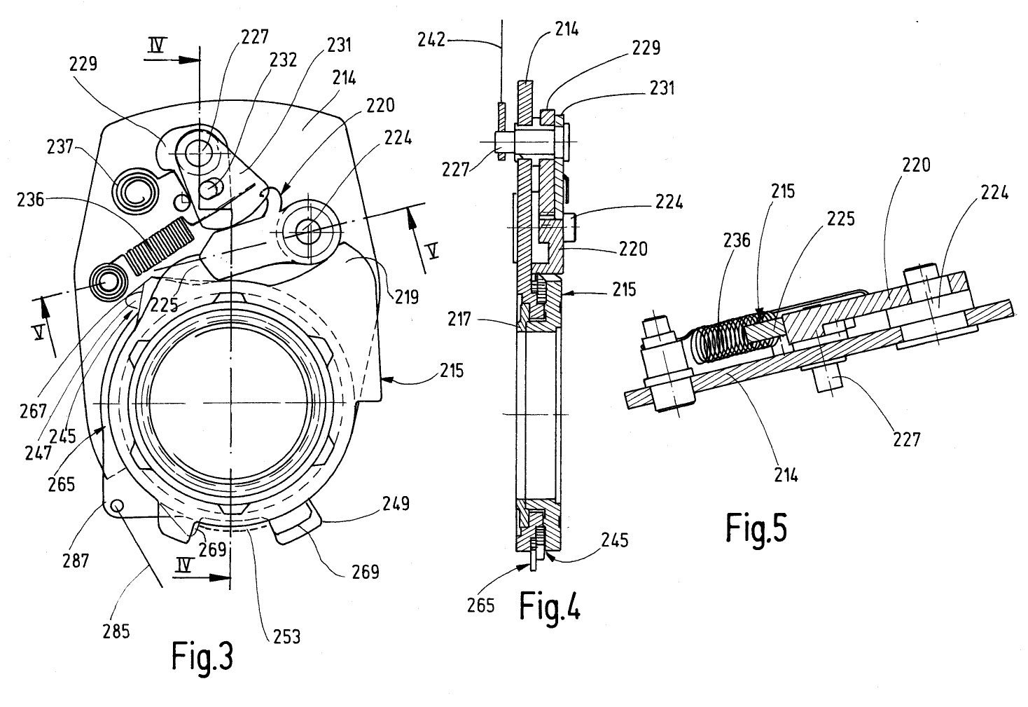

### DESCRIPTION OF THE PREFERRED EMBODIMENTS

Referring to the drawings in particular, the exemplary embodiments and modifications are identical to one another, insofar as is not described to the contrary. In the first exemplary embodiment, a vehicle seat 201 for a two-door motor vehicle has in each case a fitting 205 on its two sides for setting the inclination and for the free pivoting of a backrest 202 in relation to the corresponding seat part 203. A handwheel 207 and, between the two fittings 205, a shaft connected to the handwheel 207 are provided on one of the fittings 205 on the outside of the vehicle seat 201 for the inclination-setting function. A hand lever 208 is mounted movably on the backrest 202 for the free-pivoting function.

Each fitting 205 comprises, as its core, a first fitting part 209 and a second fitting part 211 which, in structural terms, together form a disk-shaped unit, such as is described, for example, in DE 101 05 282 B4 (corresponding to U.S. Pat. No. 6,799,806 B2), the disclosure content of each of which is expressly incorporated herein by reference. The two fitting parts 209 and 211, in the exemplary embodiment, are in geared connection with one another by means of an, in the present case self-locking, eccentric epicyclic gear which, in the present case, allows a play-free fixing of the fitting parts 209 and 211 and, for adjustment, brings about a relative rotation of the fitting parts 209 and 211 with a superposed wobbling movement. Such a geared fitting is described, for example, in DE 44 36 101 A1 (corresponding to U.S. Pat. No. 5,634,689 A1), the disclosure content of each of which is expressly incorporated herein by reference. However, other geared fittings and, theoretically, even latching fittings may also be used.

The first fitting part 209 is connected (“fixedly with respect to the seat part”) to the structure of the seat part 203, in that an adapter 213 mounted fixedly with respect to the seat part is fastened to the first fitting part 209. Each fitting 205 comprises, furthermore, a third fitting part 214 which is connected (“fixedly with respect to the backrest”) to the backrest structure of the backrest 202. The plate-shaped third fitting part 214 is mounted on the second fitting part 211 on the side facing away from the first fitting part 209 and, for the free pivoting taking place centrically in relation to the second fitting part 211, is pivotable about a central axis A, but is otherwise interlocked with the second fitting part 211. The axis A and its position within the vehicle seat 201 define the direction indications used in the present case. The conditions in a position of use (FIG. 3), suitable for sitting use, of the backrest 202 are first described below, the geared fitting used in the present case defining a plurality of possible positions of use.

An annular latching element 215 on the second fitting part 211 serves for mounting the third fitting part 214. The latching element 215 is connected fixedly to the second fitting part 211 by means of a laser weld seam (or in another way). An annular fastening disk 217, which engages over the third fitting part 214 in the bearing region, is connected fixedly, for securing the latter axially, to the second fitting part 211 and to the latching element 215. For interlocking the third fitting part 214 in the position of use, the latching element 215 has an integrally formed first latching stop 219.

A pawl 220 is mounted pivotably on the third fitting part 214 by means of a bearing bolt 224 on the side facing the second fitting part 211. The bearing bolt 224 serves at the same time as a stop for cooperating with the first latching stop 219, that is to say, in the position of use, it limits the pivoting movement of the third fitting part 214 rearwardly, specifically both in a normal situation and in a (rear) crash situation. For locking and for limiting the pivoting movement of the third fitting part 214 forwardly in a (front) crash situation, a second latching stop 225 is provided on the latching element 215 in the radial prolongation of the pawl 220. The bearing bolt 224 is designed as an eccentric bolt, that is to say it is mounted in the third fitting part 214 rotatably in relation to the latter about an axis offset with respect to the pivot axis of the pawl 220. To compensate the manufacturing tolerances and for maximum pawl engagement, the bearing bolt 224 is set and fixed such that the pawl 220 bears, free of play, with a locking region 220a against the second latching stop 225, but outside the self-locking angle range. The tangent of this bearing angle may amount, for example, to 0.25.

Mounted rotatably, parallel to the bearing bolt 224, in the third fitting part 214 by means of a bearing bush 226 is an unlocking shaft 227, on which a catching piece 229 is seated pivotably and a tension piece 231 is seated fixedly in terms of rotation. In a modified version, the catching piece 229 is seated fixedly in terms of rotation and the tension piece 231 pivotably on the unlocking shaft 227. The catching piece 229 and the tension piece 231 are pivotable about the common axis defined by the unlocking shaft 227 and, with the third fitting part 214 locked, are aligned with the pawl 220. The functioning of the catching piece 229 and tension piece 231 is described in DE 44 39 644 A1, the disclosure content of which is expressly incorporated herein by reference.

The tension piece 231 bears with a tension surface, curved eccentrically with respect to the unlocking shaft 227, against a bearing surface 220b of the pawl 220 at an angle outside the self-locking range. The tangent of this bearing angle may amount, for example, to 0.11. The tension piece 231 is acted upon by a tension spring 236 which is designed as a helical tension spring, so that the tension piece 231 bears with prestress against the pawl 220. As a result, the third fitting part 214 is interlocked, free of play, with the latching element 215 and consequently with the second fitting part 211.

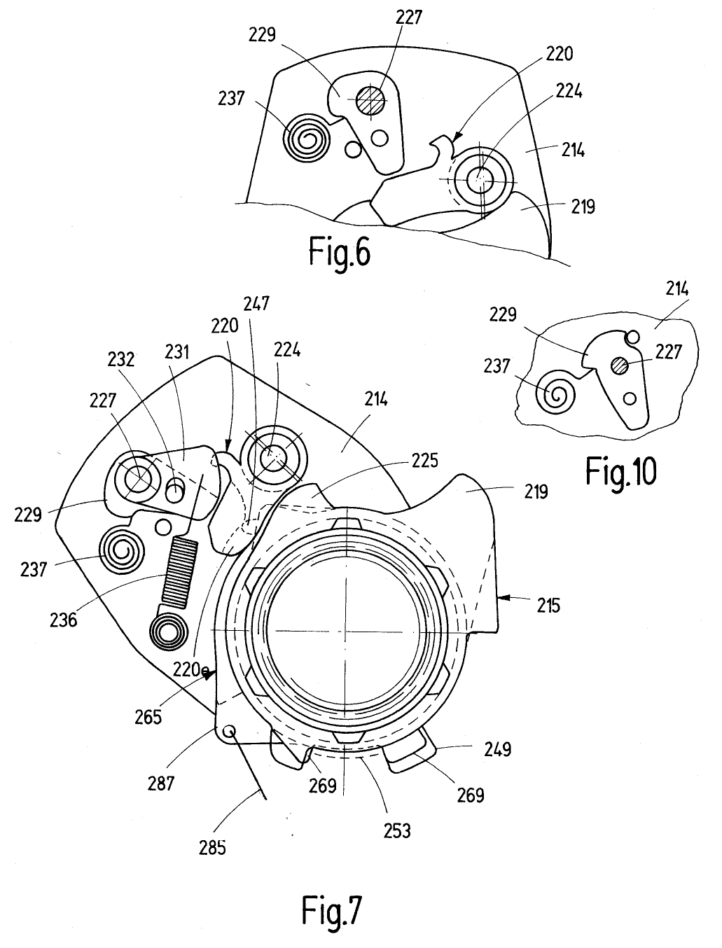

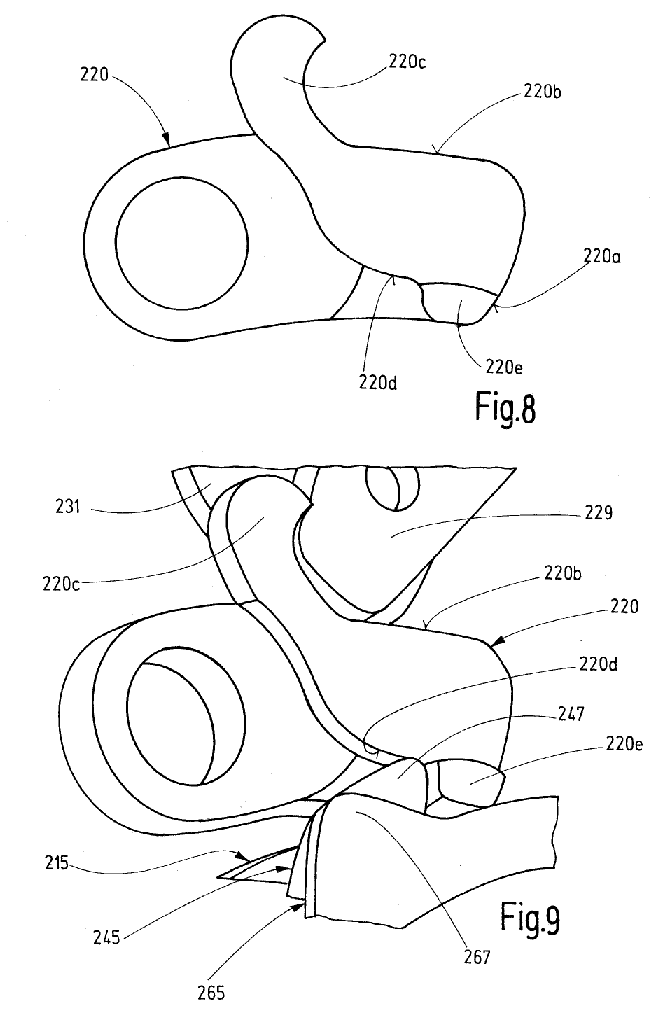

The catching piece 229 is acted upon by a spiral spring 237 and bears against a stop of the third fitting part 214. Normally, that is to say for normal sitting use in the position of use, the pawl 220 is held in its position by the tension piece 231, and the catching piece 229 is arranged at a short distance from the pawl 220 (FIG. 6). In the event of a crash, when crash forces act on the pawl 220, the tension piece 231 can open on account of the absence of self-locking. After a slight pivoting movement of the pawl 220, the latter comes to bear against the catching piece 229, preferably with the bearing surface 220b. The catching piece 229 then supports the pawl 220 which bears against the catching piece 229 within the self-locking range, preferably tangentially or concentrically and as far as possible over a large area. This prevents the pawl 220 from opening. The tangent of the bearing angle is preferably zero. FIG. 10 illustrates a modification of the catching piece 229 which cooperates with a stop, offset with respect to the unlocking shaft 227, of the third fitting part 214 and which for this purpose has a radially projecting material portion.

The catching piece 229 and the tension piece 231 are coupled to one another for take-up with idle travel by means of a mortise-and-tenon guide 232. For this purpose, the tension piece 231 has a slot which is curved about the unlocking shaft 227 and into which a tenon of the catching piece 229 engages. A cover 238 fastened to the third fitting part 214 covers the pawl 220 together with the bearing bolt 224, the catching piece 229, the tension piece 231 and the springs 236 and 237 and protects these against soiling.

On that side of the third fitting part 214 which faces away from the second fitting part 211, the unlocking shaft 227 has connected to it fixedly in terms of rotation an arm or lever to which is fastened a first cable pull 242 connected operatively to the hand lever 208. Alternatively, the unlocking shaft 227 may also be actuated via an electric actuator, for example a servomotor or the like.

By the third fitting part 214 being unlocked and the backrest 202 being pivoted forward, the backrest 202 changes from the position of use into a freely pivoted position. To unlock the third fitting part 214, the unlocking shaft 227 is rotated about its own axis by means of the first cable pull 242. The unlocking shaft 227 takes up the element, in the present case the tension piece 231, connected fixedly in terms of rotation to it and opens it, that is to say separates and/or removes it from the pawl 220. At the same time, the respective element, that is to say, in the present case, the tension piece 231, by means of the mortise-and-tenon guide 232, takes up the other element in each case, that is to say, in the present case, the catching piece 229, in order to release the pawl 220. The pivoting catching piece 229 comes to bear against an essentially radially projecting unlocking finger 220c of the pawl 220 and thereby pulls up the latter. The pawl 220 is consequently opened completely.

On at least one vehicle seat side (or on both vehicle seat sides), the fitting 205 is designed such that a securing ring 245 is mounted rotatably, concentrically to the axis A, on a step of the third fitting part 214 (or, selectively, the latching element 215 or the second fitting part 211) and is arranged in the axial direction between the latching element 215 and the third fitting part 214. The securing ring 245 has a securing boss 247 which is arranged so as to project radially outward. The securing ring 245, together with the securing boss 247, is provided for fixing the third fitting part 214 in the freely pivoted position of the backrest 202, for which purpose it cooperates with the pawl 220. For this purpose, the pawl 220 has a securing contour 220d with which the pawl 220 can engage behind the securing boss 247. With respect to the locking region 220a of the pawl 220, the securing contour 220d is in a plane offset axially thereto. The securing ring 245 has, in addition to the securing boss 247, two radially outward-projecting blocking fingers 269 which receive between them, with play, a blocking stop 253, projecting parallel to the axis A, of the adapter 213, with the result that the securing ring 245 is retained. During the setting of the inclination of the backrest 202, the play compensates the influence of the wobbling movement on the position of the securing ring 245.

A switching ring 265 is mounted rotatably, concentrically to the axis A, on a further step of the third fitting part 214 in a way corresponding to the mounting of the securing ring 245. The switching ring 265 is arranged in the axial direction between the securing ring 245 and the third fitting part 214, the axial dimension of the pawl 220 corresponding to the sum of the axial dimension of the switching ring 265 plus the axial dimension of the securing ring 245 plus the axial dimension of the latching element 215. The switching ring 265 has a radially outward-projecting switching cam 267 which is arranged in the circumferential direction in an angular range between the second latching element 225 and the securing boss 247 and which has a flank growing radially in the reverse pivoting direction of the backrest 202. For cooperation with the switching cam 267, the pawl 220 has a switching finger 220e which projects essentially axially from the pawl. With respect to the locking region 220a and the securing contour 220d, the switching finger 220e extends into a plane offset axially thereto. The switching ring 265 has, in addition to the switching cam 267, a stop bass 249 which likewise projects radially outward. Between the stop cam 249 and the adapter 213, a tension spring acts, which acts upon the switching ring 245 in the circumferential direction with respect to the axis A. This prestress holds the stop cam 249 in bearing contact against the blocking stop 253.

The vehicle seat 201 is longitudinally adjustable, that is to say can be set in the longitudinal position of the seat, by means of a longitudinal adjuster 281. The longitudinal adjuster 281 having two pairs of seat rails can, for this purpose, be unlocked by means of a grip 283 and locks automatically after the release of the grip 283. However, the longitudinal adjuster 281 is also unlocked during the free pivoting of the backrest 202 by means of the hand lever 208, so that the vehicle seat 201 can be moved forward (by means of the longitudinal adjuster 281), in order, in addition to the free pivoting of the backrest 202, to make it easier to have access to the rear seats. The unlocking of the longitudinal adjuster 281 in this case takes place directly by means of the hand lever 208 or indirectly, in that, in the case of the fitting 205, there is provided in a way known per se, on the vehicle seat side without a securing ring 245, an unlocking ring which is taken up during the forward pivoting of the backrest 202 and then activates the locking of the longitudinal adjuster 281 by means of a Bowden cable pull or the like.

A memory device of the longitudinal adjuster 281, by means of which the longitudinal position of the seat (memory position) set before free pivoting can be found, is connected operatively to the fitting 205 by means of a second cable pull 285, preferably a Bowden cable pull. For this purpose, the switching ring 265 has a radially projecting trigger finger 287 between the switching cam 267 and the stop cam 249. The second cable pull 285 is fastened to this trigger finger 287, for example at a trigger pin projecting axially from the trigger finger 287, that is to say the memory device of the longitudinal adjuster 281 activates the switching ring 265.

The free pivoting of the backrest 202 is initiated by the unlocking of the third fitting part 214 on both vehicle seat sides. The pawl 220 is lifted out radially from the second latching stop 225 of the latching element 215 of the second fitting part 211 in the way described above. With the pivoting movement of the backrest 202 forward, the free end of the pawl 220 successively, and in the various planes, comes with the locking region 220a onto the radially outward-pointing side of the second latching stop 225, with the switching finger 220d onto that of the switching cam 267 and with the securing contour 220d onto that of the securing boss 247. After the securing boss 247 has been passed, the outer contour of the securing ring 245 springs back radially. Due to the shape of the securing contour 220d, the pawl 220 then drops behind the securing boss 247 (radially inward) and engages behind the latter with the securing contour 220d (FIG. 7). The third fitting part 214 is consequently secured. The pawl 220 is held in this position, depending on the particular version, by spring prestress or by self-locking, in which case, however, the tension piece 231 and the catching piece 229 do not secure the pawl 220. In a version without a switching ring 265, however, the pawl 220 can be secured in said position by the tension piece 231 and the catching piece 229.

The forward-pivoted backrest 202 is then in its freely pivoted position which allows unimpeded access to the rear seats and which is secured by the third fitting part 214 being fixed. At the same time, the vehicle seat 201 is in a front longitudinal position of the seat. Since the angular position of the securing boss 247 is constant (with the exception of a very slight oscillating movement as a projection of the wobbling movement) with respect to the angular position of the first fitting part 209 and of the adapter 213 together with the blocking stop 253, the third fitting part 214, and consequently the backrest 202, are always secured in the same position in relation to the first fitting part 209, and consequently in relation to the seat part 203, that is to say independently of the set inclination of the backrest 2.

In order to return to the initial position, first, the vehicle seat 201 is moved rearwardly again, for example by a pull on the backrest 2. When the memory position is reached, the longitudinal adjuster 281 locks and at the same time pulls on the second cable pull 285. The second cable pull 285 engaging on the trigger finger 287 then rotates the switching ring 265 counter to its prestress in the forward pivoting direction of the backrest 202. The pawl 220, more specifically its switching finger 220e, passes onto the radially growing flank of the (moving) switching cam 267 of the switching ring 265. As a result, with the progressive pivoting movement of the switching ring 265, the pawl 220 is lifted out outward in the radial direction, that is to say the cooperation of the pawl 220 and securing ring 245 is canceled, and the backrest 202 can be pivoted in reverse, unimpeded. The pawl 220 then passes over the securing boss 247 and the second latching stop 225 and, when the initial position is reached, drops with its locking region 220a again behind the second latching stop 225 (radially inward), so that the fitting 205 is locked again. The switching ring 265, not acted upon any further by the second cable pull 285, is drawn back into its initial position again by the assigned tension spring.

In a modified version without a switching ring 265, in which the pawl 220 is secured by the tension piece 231 and the catching piece 229 in the freely pivoted position of the backrest 202, a release of the pawl 220 which is dropped behind the securing boss 247 takes place by means of an actuation of the hand lever 208. This is possible even when the memory position is not reached, for example because of articles in the foot space, that is to say a reset function is then also implemented.

Whereas, in the first exemplary embodiment, the securing ring 245 is virtually fixed in terms of rotation and the switching ring 265 is rotatable and is held by a spring, modifications to this are possible, according to which the switching ring 265 is virtually fixed in terms of rotation and the securing ring 245 is rotatable and is held (fixed) in a suitable way.

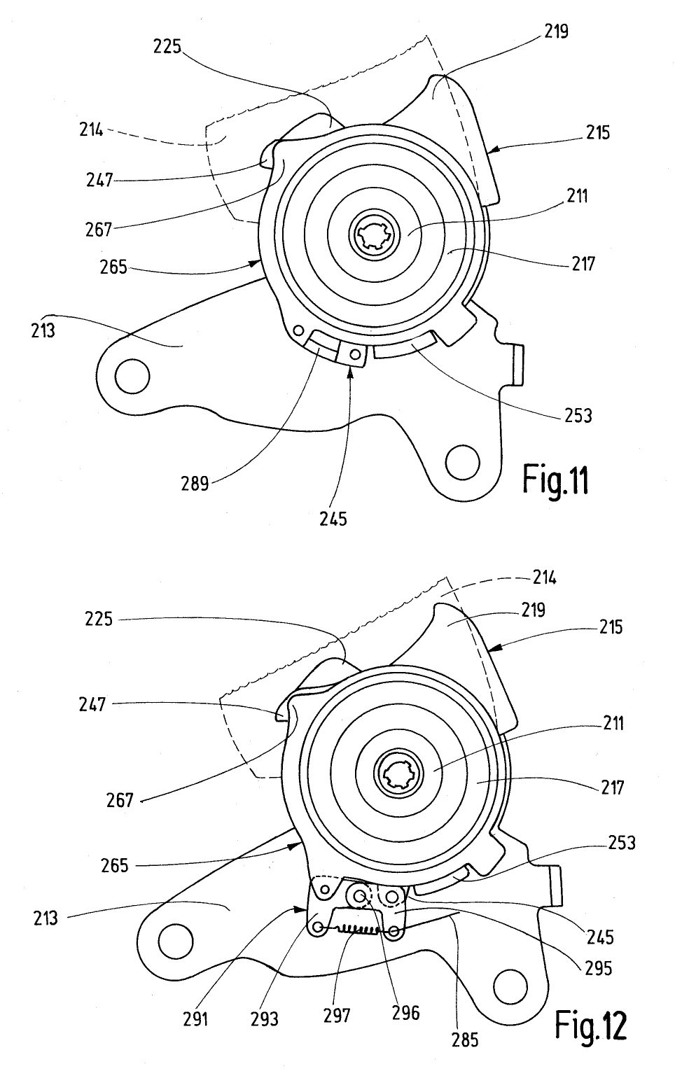

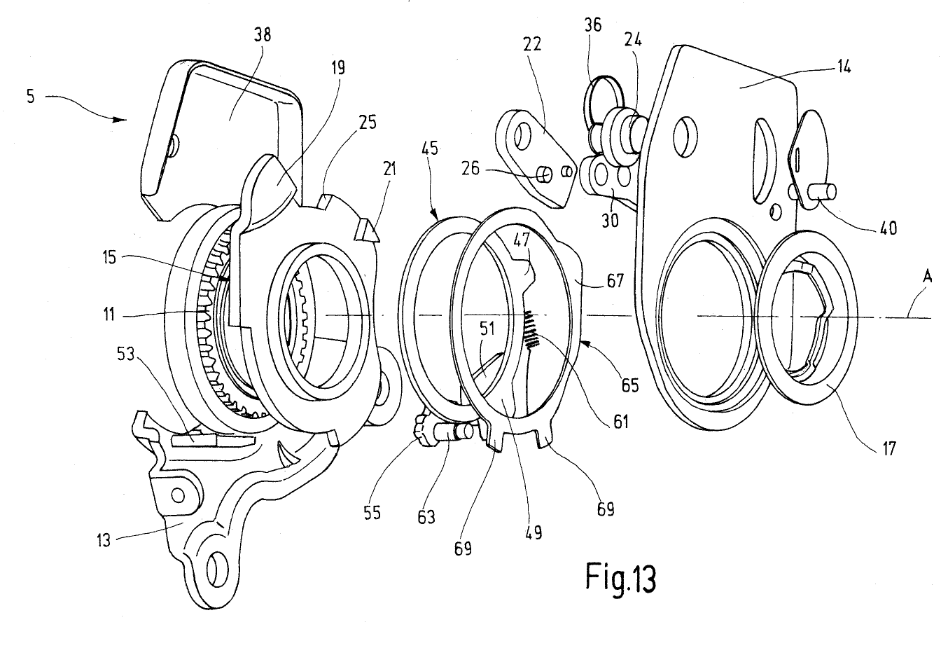

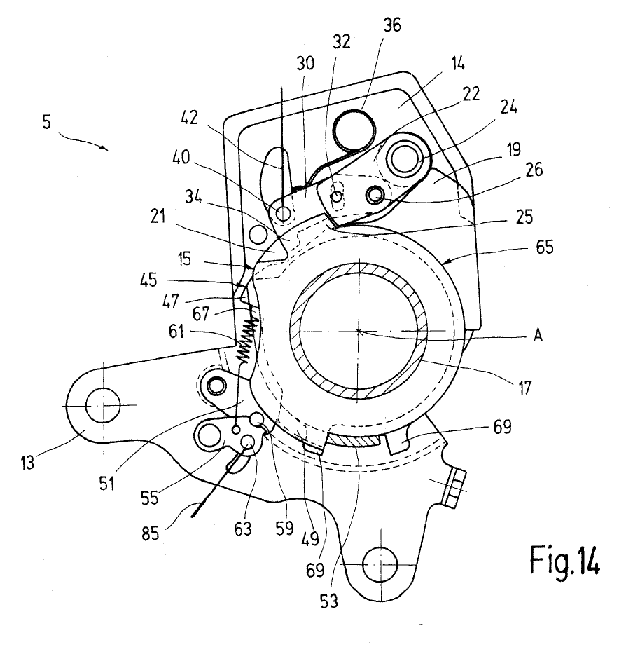

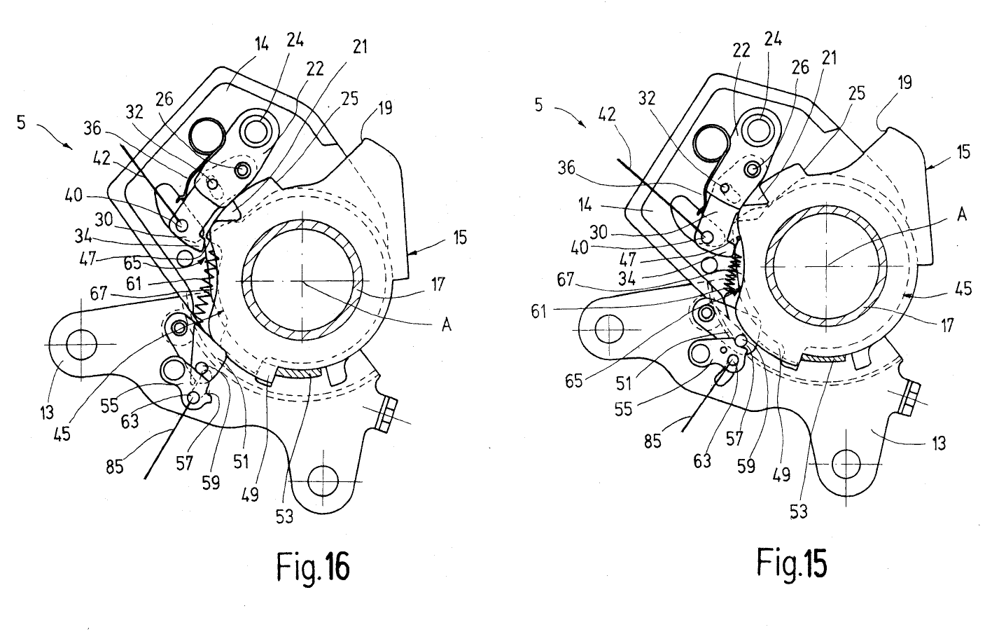

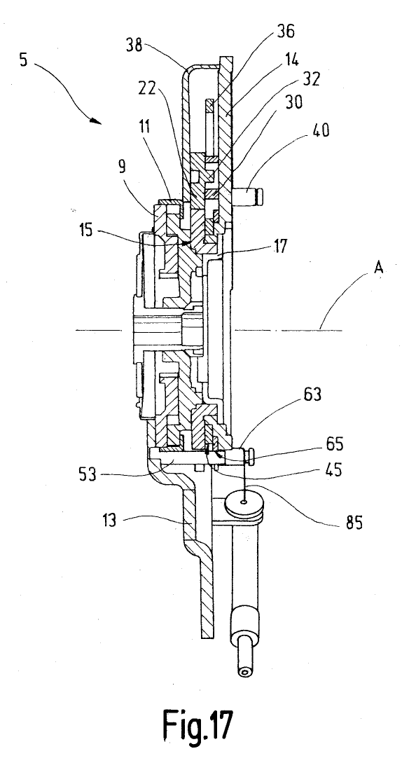

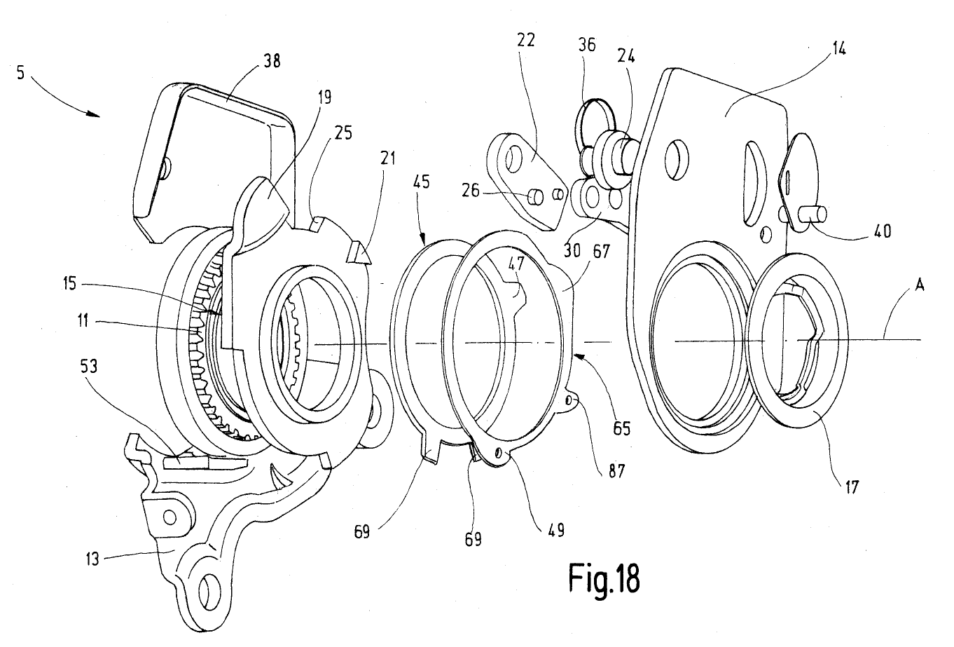

Such a modification of the first exemplary embodiment is illustrated in FIG. 11 with a buffer 289, acting in the circumferential direction, between the virtually rotationally fixed switching ring 265 and the securing ring 245. The buffer 289 is a body which can be compressed elastically, for example a piece of rubber. Instead of the buffer 289, a spring or another elastic element may also be used. Such a design, which is useful particularly for vehicle seats 201 without a memorized longitudinal adjuster 281, makes it possible, in the freely pivoted position, to have a directed desecuring of the backrest 202 by action upon the backrest 202, for example on the backrest head, by means of a force exerting a reverse pivoting moment, in that, by means of the rearward pivoting of the third fitting part 214, the pawl 220 and the securing ring 245 can be drawn, with the buffer 289 being compressed, along the switching cam 267 of the switching ring 265, until the pawl 220 opens.

For an addition to the first exemplary embodiment, the securing ring 245 is likewise retained virtually fixedly in terms of rotation, that is to say by means of the blocking finger 269. The switching ring 265 is fixed to the securing ring 245 by means of a toggle lever 291, as illustrated in FIG. 12. The toggle lever 291 consists of a first lever 293 articulated on the switching ring 265 and of a second lever 295 which is articulated on the securing ring 245, which levers are connected to one another in an articulated manner by means of a connecting joint 296 and are held in an extended position by a toggle lever spring 297 active between the two levers 293 and 295. The second cable pull 285 is suspended on the second lever 295 and is led to the memory device of the longitudinal adjuster 281. During return from the freely pivoted position into the initial position, the memory device, when the memory position is reached, pulls on the second cable pull 285 and brings the toggle lever 291 into a bent position counter to the force of the toggle lever spring 297. As a result, the switching ring 265 is rotated in relation to the securing ring 245, and the pawl 220 is opened by means of the switching cam 267, so that the backrest 202 can be pivoted back into the position of use.

In all further exemplary embodiments, a vehicle seat 1 for a two-door motor vehicle has in each case a fitting 5 on its two sides for setting the inclination and for the free pivoting of its backrest 2 in relation to its seat part 3. A handwheel 7 and, between the two fittings 5, a shaft connected to the handwheel 7 are provided on the outside of the vehicle seat 1 on one of the fittings 5 for the inclination-setting function, while a hand lever 8 is mounted movably on the backrest 2 for the free-pivoting function.

Each fitting 5 comprises, as its core, a first fitting part 9 and a second fitting part 11 which, in structural terms, together form a disk-shaped unit. In the exemplary embodiment, the two fitting parts 9 and 11 are in geared connection with one another by means of an, in the present case self-locking, eccentric epicyclic gear which, in the present case, allows a play-free fixing of the fitting parts 9 and 11 and, for adjustment, brings about a relative rotation of the fitting parts 9 and 11 with a superposed wobbling movement. Such a geared fitting is described, for example, in DE 44 36 101 A1 (corresponding to U.S. Pat. No. 5,634,689 A1), the disclosure content of each of which is expressly incorporated herein by reference. However, other geared fittings and, theoretically, even latching fittings may also be used.

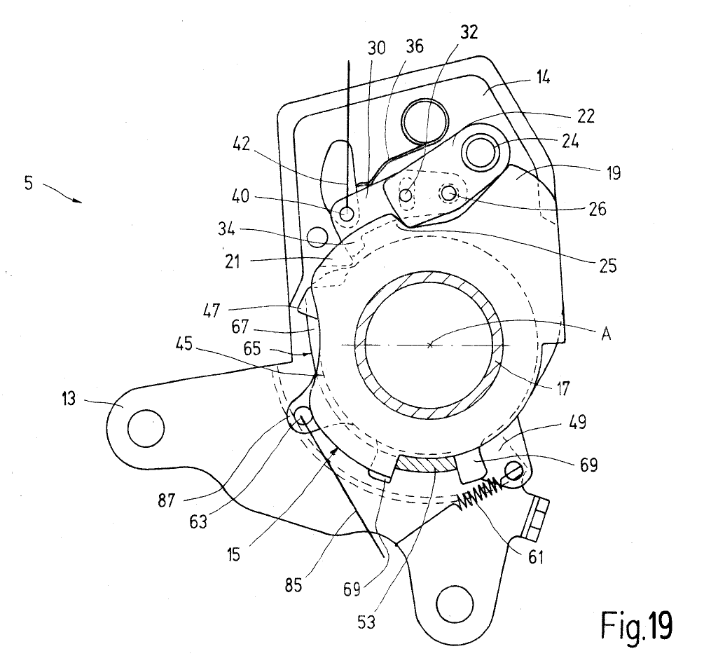

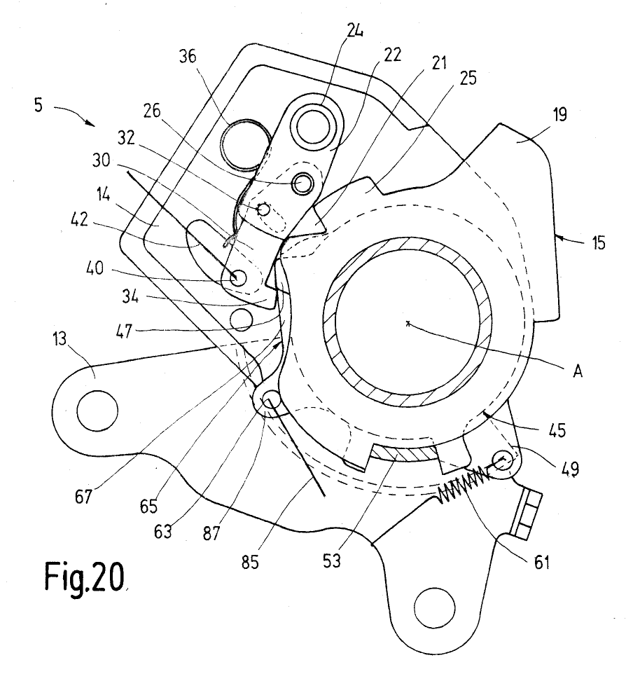

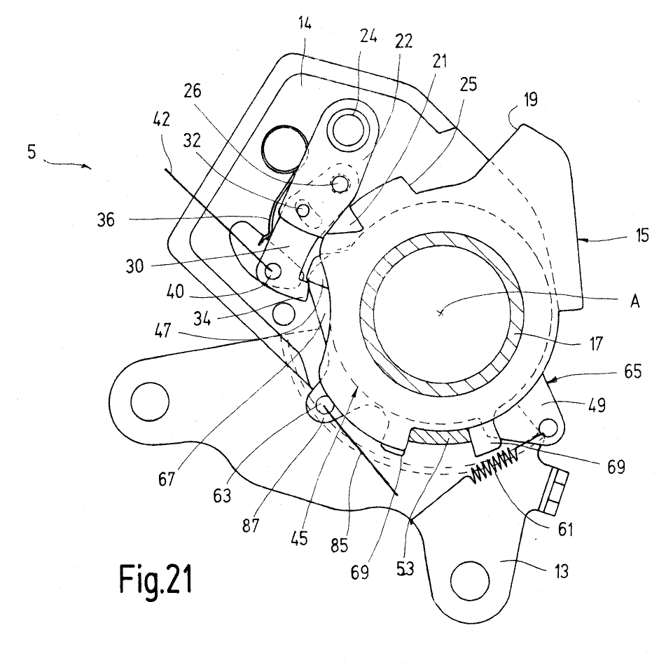

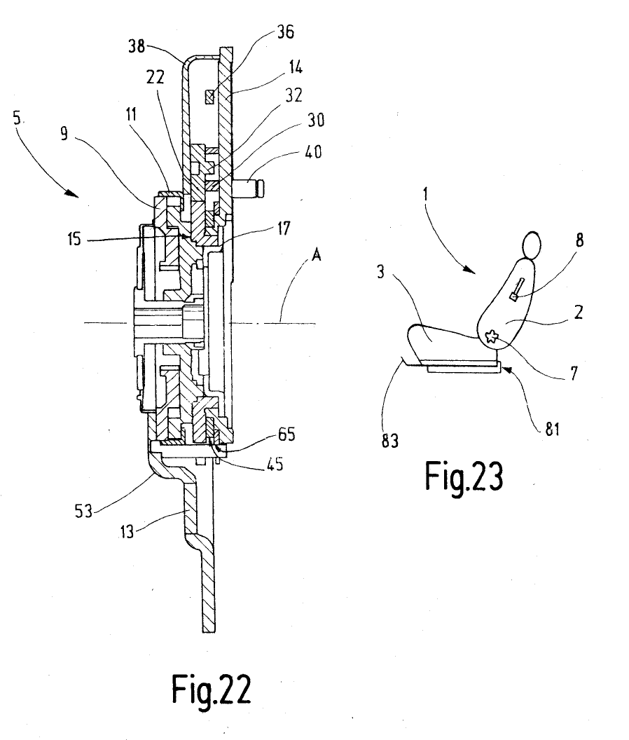

The first fitting part 9 is connected (“fixedly with respect to the seat part”) to the structure of the seat part 3, in that an adapter 13 mounted fixedly with respect to the seat part is fastened to the first fitting part 9. Each fitting 5 comprises, furthermore, a third fitting part 14 which is connected (“fixedly with respect to the backrest”) to the backrest structure of the backrest 2. The plate-shaped third fitting part 14 is mounted on the second fitting part 11 on the side facing away from the first fitting part 9 and is pivotable about a central axis A for the free pivoting taking place centrically in relation to the second fitting part 11, but is otherwise interlocked with the second fitting part 11. The axis A and its position within the vehicle seat 1 define the direction indications used in the present case. The conditions in a position of use (FIGS. 14, 19), suitable for sitting use, of the backrest 202 are first described again below, the geared fitting used in the present case defining a plurality of possible positions of use.

In the second and third exemplary embodiment, an annular latching element 15 on the second fitting part 11 serves for mounting the third fitting part 14. The latching element 15 is connected fixedly to the second fitting part 11 by means of a laser weld seam (or in another way). An annular fastening disk 17 which engages over the third fitting part 14 in the bearing region is connected fixedly, for securing the latter axially, to the second fitting part 11 and to the latching element 15.

To lock the third fitting part 14, the latching element 15 also has, in addition to an integrally formed first latching stop 19, a latching step 21. The latching step 21 provided at the margin of the latching element 15 projects axially toward the third fitting part 14 with respect to the axis A and is formed by two axially opposite bends offset in the circumferential direction. A catching pawl 22 is mounted pivotably on the third fitting part 14 by means of a bearing bolt 24 on the side facing the second fitting part 11. The bearing bolt 24 serves at the same time as a stop for cooperation with the first latching stop 19, that is to say it limits the pivoting movement of the third fitting part 14 rearwardly, specifically both in a normal situation and in a (rear) crash situation. To limit the pivoting movement of the third fitting part 14 forwardly in a (front) crash situation, a second latching stop 25 is provided in the radial prolongation of the catching pawl 22 and at a short distance from the latter. In the event of a front crash, the catching pawl 22 then comes to bear against the second latching stop 25, without the latter exerting an opening moment on the catching pawl 22.

A tension pawl 30 is mounted pivotably on a bearing pin 26 of the catching pawl 22 and is additionally coupled to the catching pawl 22 by means of a mortise-and-tenon guide 32. The tension pawl 30, which has an integrally formed tension tooth 34, is acted upon by a tension spring 36 designed as a spiral spring and therefore bears with prestress, with this tension tooth 34, against the rear flank of the latching step 21. As a result, the third fitting part 14 is interlocked, free of play, with the latching element 15 and consequently with the second fitting part 11. In this case, the tension spring 36, as a common spring, prestresses both the catching pawl 22 and the tension pawl 30 in the closing direction, that is to say in the radial direction. A cover 38 fastened to the third fitting part 14 covers the tension pawl 30, the catching pawl 22, together with a bearing bolt 24, and the tension spring 36. On that side of the tension pawl 30 which faces away from the second fitting part, an unlocking pin 40 projects axially from the tension pawl 30 and penetrates through the third fitting part 14 in a curved slotted link. On that side of the third fitting part 14 which faces away from the second fitting part 11, a first cable pull 42 connected operatively to the hand lever 8 is fastened to the unlocking pin 40. The unlocking pin 40 may also be provided on this side of the third fitting part 14 with a cover for the slotted link. To unlock the third fitting part 14, the unlocking pin 40 is moved (in the slotted link) by means of the first cable pull 42 and at the same time takes up the tension pawl 30 and opens it, that is to say separates it from the latching step 21, the tension pawl 30 opening the catching pawl 22.

On at least one vehicle seat side (or on both vehicle seat sides), the fitting 5 is designed such that a securing ring 45 is mounted rotatably, concentrically to the axis A, on a step of the third fitting part 14 (or, selectively, the latching element 15 or the second fitting part 11) and is arranged in the axial direction between the latching element 15 and the third fitting part 14 in the plane of the latching step 21. The securing ring 45 has a securing boss 47 which projects radially outward and which is arranged in the vicinity of the latching step 21. The securing ring 45 together with the securing boss 47 is provided for fixing the third fitting part 14 in the freely pivoted position of the backrest 2, for which purpose said securing boss cooperates with the tension pawl 30.

The second and the third exemplary embodiment are to that extent identical to one another. According to the second exemplary embodiment, the securing ring 45 also has a stop boss 49 which likewise projects radially outward. With respect to the axis A, a blocking lever 51 mounted pivotably on the adapter 13 acts in the circumferential direction upon the securing ring 45 at the stop boss 49 (outside self-locking) and holds the latter in bearing contact against a blocking stop 53 projecting axially from the adapter 13. The blocking lever 51 is acted upon and secured by a tension lever 55 likewise mounted pivotably on the adapter 13, in that the tension lever 55 bears with a concave tension contour 57 against a blocking pin 59 projecting axially from the blocking lever 51, without the blocking pin 59 being capable of exerting an opening moment on the tension lever 55. A tension spring 61 acting between the securing boss 47 and the tension lever 55 ensures the necessary prestress of the tension lever 55. A trigger pin 63 projects in the axial direction from the tension lever 55 and in the present case projects through a slotted link in the adapter 13.

Both in the second and in the third exemplary embodiment, a switching ring 65 is mounted rotatably, concentrically to the axis A, on a further step of the third fitting part 14 in a way corresponding to the mounting of the securing ring 45. The switching ring 65 is arranged in the axial direction between the securing ring 45 and the third fitting part 14 in a plane parallel to the latching step 21, the axial dimension of the tension pawl 30 corresponding to the sum of the axial dimension of the switching ring 65 plus the axial dimension of the securing ring 45. The axial dimension of the securing ring 45 corresponds to the axial dimension of the latching step 21. The switching ring 65 has a switching cam 67 which projects radially outward and which is arranged in the circumferential direction in an angular range between the latching step 21 and the securing boss 47 and has a flank growing radially in the reverse pivoting direction of the backrest 2. In the second exemplary embodiment, furthermore, the switching ring 65 has two blocking fingers 69 which project radially outward and which receive between them, with play, the blocking stop 53 of the adapter 13, with the result that the switching ring 65 is retained. During the setting of the inclination of the backrest 2, the play compensates the influence of the wobbling movement of the fitting parts 9 and 11 in relation to one another on the position of the switching ring 65.

In the second and third exemplary embodiments, the vehicle seat 1 is longitudinally adjustable, that is to say can be set in the longitudinal position of the seat, by means of a longitudinal adjuster 81. For this purpose, the longitudinal adjuster 81 having two pairs of seat rails can be unlocked by means of a grip 83 and locks automatically after the release of the grip 83. However, even during the free pivoting of the backrest 2 by means of the hand lever 8, the longitudinal adjuster 81 is unlocked, so that the vehicle seat 1 can be moved forward (by means of the longitudinal adjuster 81), in order, in addition to the free pivoting of the backrest 2, to make it easer to have access to the rear seats. The unlocking of the longitudinal adjuster 81 in this case takes place directly by means of the hand lever 8 or indirectly in that, in the case of the fitting 5, an unlocking ring is provided in a way known per se on the vehicle seat side without a securing ring 45 and, during the forward pivoting of the backrest 2, is taken up and then activates the locking of the longitudinal adjuster 81 by means of a Bowden cable pull or the like. A memory device of the longitudinal adjuster 81, by means of which the longitudinal position of the seat (memory position) set before the free pivoting can be found, is connected operatively to the fitting 5 by means of the second cable pull 85, preferably a Bowden cable pull.

The free pivoting of the backrest 2 is initiated by the unlocking of the third fitting part 14 on both vehicle seat sides. In the second and third exemplary embodiments, the tension pawl 30 and the catching pawl 22 are lifted out radially from the latching element 15 of the second fitting part 11 in the way described above. With the pivoting movement of the backrest 2 forward, the tension pawl 30 passes successively with its tension tooth 34 onto the radially outward-pointing side of the latching step 21, of the switching cam 67 and of the securing boss 47. After the securing boss 47 has been passed, the outer contour of the securing ring 45 springs back radially. The tension pawl 30 then drops behind the securing boss 47 (radially inward) and engages behind the latter (within the self-locking), with the result that the third fitting part 14 is fixed.

The forward-pivoted backrest 2 is then in its freely pivoted position which allows unimpeded access to the rear seats and which is secured by fixing the third fitting part 14. At the same time, the vehicle seat 1 is in a front longitudinal position of the seat. Since the angular position of the securing boss 47 is constant (with the exception of a very slight oscillating movement as a projection of the wobbling movement) with respect to the angular position of the first fitting part 9 and of the adapter 13, together with the blocking stop 53, the third fitting part 14, and consequently the backrest 2, are always secured in the same position in relation to the first fitting part 9, and consequently in relation to the seat part 3, that is to say independently of the set inclination of the backrest 2.

In order to return to the initial position, first, the vehicle seat 1 is moved rearward again, for example by a pull on the backrest 2. When the memory position is reached, the longitudinal adjuster 81 locks and at the same time pulls on the second cable pull 85.

In the second exemplary embodiment, the second cable pull 85 is mounted on the trigger pin 63 of the tension lever 55, that is to say the memory device activates the acting means of the securing ring 45. When the memory device of the longitudinal adjuster 81 pulls on the second cable pull 85, therefore, the second cable pull 85 pivots the tension lever 55, with the result that the blocking lever 51 lying outside the self-locking is also freed. The third fitting part 14 introducing the force on the backrest 2 takes up, by means of the tension pawl 30, the then freely rotatable securing ring 45 in the circumferential direction together with the backrest 2. The tension tooth 34 passes onto the radially growing flank of the (retained) switching cam 67 of the switching ring 65. As a result, with the progressive rearward pivoting movement of the backrest 2, the tension pawl 30 is lifted out outward in the radial direction, that is to say the cooperation of the tension pawl 30 and securing ring 45 is canceled, and the backrest 2 can be pivoted in reverse, unimpeded. The tension pawl 30 then passes over the securing boss 47 and the latching step 21 and, when the initial position is reached, drops behind the latching step 21 (radially inward) again, so that the fitting 5 is locked again. The securing ring 45 released from the tension pawl 30 is drawn back by the tension spring 61, whereupon the blocking lever 51 and the tension lever 55 also resume their initial positions.

If the memory position is not reached, for example because of articles in the foot space, a release of the tension pawl 30 which is dropped behind the securing boss 47 is possible by means of an actuation of the hand lever 8, that is to say a reset function is implemented.

The third exemplary embodiment is identical to the second exemplary embodiment, insofar as is not described to the contrary, and therefore identical or identically acting components bear the same reference symbols.

According to the third exemplary embodiment, the securing ring 45 also has, in addition to the securing boss 47, two blocking fingers 69 which project radially outward and which receive between them, with play, the blocking stop 53 of the adapter 13, with the result that the securing ring 45 is retained. During the setting of the inclination of the backrest 2, the play compensates the influence of the wobbling movement on the position of the securing ring 45. The switching ring 65 also has, in addition to the switching cam 67, a stop cam 49 which likewise projects radially outward. A tension spring 61 acts between the stop cam 49 and the adapter 13 and acts upon the securing ring 45 in the circumferential direction with respect to the axis A. This prestress holds the stop cam 49 in bearing contact against the blocking stop 53. The switching ring 65 also has a radially projecting trigger finger 87 between the switching cam 67 and the stop cam 49. The second cable pull 85 is fastened to this trigger finger 87, for example at a trigger pin 63 projecting axially from the trigger finger 87, that is to say the memory device of the longitudinal adjuster 81 activates the switching ring 65.

The locking of the third fitting part 14 in the initial position, that is to say when the backrest 2 is in a position of use, the unlocking of the third fitting part 14, the free pivoting of the backrest 2, the fixing of the third fitting part 14 in the freely pivoted position of the backrest 2 and the pushing of the vehicle seat 1 back into the memory position are identical in the second and the third exemplary embodiment. When the memory position is reached, the longitudinal adjuster 81 locks and at the same time pulls on the second cable pull 85.

The second cable pull 85 engaging on the trigger finger 87 then rotates the switching ring 65 counter to its prestress in the forward pivoting direction of the backrest 2. The tension tooth 34 passes onto the radially growing flank of the (moving) switching cam 67 of the switching ring 65. As a result, with the progressive pivoting movement of the switching ring 65, the tension pawl 30 is lifted out outward in the radial direction, that is to say the cooperation of the tension pawl 30 and securing ring 45 is canceled, and the backrest 2 can be pivoted in reverse, unimpeded. The tension pawl 30 then passes over the securing boss 47 and the latching step 21 and, when the initial position is reached, drops behind the latching step 21 (radially inward) again, so that the fitting 5 is locked again. The switching ring 65 released by the second cable pull 85 is drawn back into its initial position by the tension spring 61. The reset function by means of the actuation of the hand lever 8 when the memory position is not reached is also implemented in the third exemplary embodiment.

Whereas, in the third exemplary embodiment, the securing ring 45 is set virtually fixedly in terms of rotation and the switching ring 65 is rotatable and is held by a spring, a modification to this is possible, whereby, according to the second exemplary embodiment, the switching ring 65 is virtually fixed in terms of rotation and the securing ring 45 is rotatable and is held by a spring. Such a modification, which is useful particularly for vehicle seats 1 without a memorized longitudinal adjuster 81, makes it possible, in the freely pivoted position, to have a directed desecuring of the backrest 2 by action upon the backrest 2, for example on the backrest head, in that, by means of the pivoting of the third fitting part 14, the tension pawl 30 and the securing ring 45 can be drawn along the switching cam 67 of the switching ring 65 until the tension pawl 30 opens.

While specific embodiments of the invention have been shown and described in detail to illustrate the application of the principles of the invention, it will be understood that the invention may be embodied otherwise without departing from such principles.

1. A fitting for a vehicle seat, the fitting comprising:
a first fitting part fixed with respect to a seat part;
a second fitting part, rotatable in relation to the first fitting part, for setting the inclination of a backrest of the vehicle seat between a plurality of positions of use;
a third fitting part which is fixed with respect to the backrest, said third fitting part being interlockable with said second fitting part and pivoting about an axis in relation to said second fitting part for a centric pivoting and a free pivoting of the backrest, said third fitting part being securable in the freely pivoted position of the backrest; and
a pawl for locking said third fitting part in any of the positions of use of the backrest and securing said third fitting part in the freely pivoted position of the backrest.

2. The fitting as claimed in claim 1, further comprising: a securing ring, wherein said pawl secures said third fitting part in the freely pivoted position of the backrest by cooperation with said securing ring and said securing ring is mounted on said second fitting part and is retained on said first fitting part.

3. The fitting as claimed in claim 2, wherein said pawl, during cooperation with said securing ring, engages behind a securing boss of said securing ring, for cooperation with said securing ring, said pawl dropping behind said securing boss radially inward and, when cooperation is canceled, being lifted out radially outward.

4. The fitting as claimed in claim 2, further comprising: a switching ring rotatable in relation to said securing ring, wherein during a relative rotation of said securing ring and said switching ring, said switching ring cancels the cooperation of said pawl and of said securing ring.

5. The fitting as claimed in claim 4, wherein:
said switching ring has a switching cam with a flank growing radially with respect to said axis in the reverse pivoting direction of the backrest, to cancel the cooperation of said pawl and said securing ring;
said securing ring or said switching ring rotates in the forward pivoting direction of the backrest counter to a prestress, with the result that said pawl, which has a switching finger for cooperation with the switching ring, passes onto the radially growing flank of the switching cam of the switching ring and, with the progressive pivoting movement of the securing ring or of the switching ring, is lifted out.

6. The fitting as claimed in claim 4, further comprising: a toggle lever and an adapter fixed to said first fitting part, wherein either said securing ring or said switching ring is fixed, by means of said toggle lever, in relation to said first fitting part or in relation to said adapter or in relation to said securing ring.

7. The fitting as claimed in claim 1 further comprising: a latching element fixed to said second fitting part, wherein said pawl interlocks said third fitting part free of play, with said second fitting part, in the positions of use of the backrest, by means of a locking region and said latching element.

8. The fitting as claimed in claim 1, further comprising an unlocking shaft, said unlocking shaft, upon rotation about an axis thereof, unlocks said pawl at least indirectly, said unlocking shaft being mounted rotatably in said third fitting part.

9. The fitting as claimed in claim 8, further comprising a spring loaded tension piece wherein, for locking said third fitting part in the positions of use of the backrest, said spring-loaded tension piece holds the pawl in position during the normal use of the seat, by action upon a bearing surface of the pawl.

10. The fitting as claimed in claim 9, further comprising a spring-loaded, catching piece wherein, for locking said third fitting part in the positions of use of the backrest said spring-loaded, catching piece supports said pawl in the event of a crash of the vehicle.

11. The fitting as claimed in claim 10, wherein said tension piece and said catching piece are pivotable about a common axis defined by said unlocking shaft, said tension piece being seated fixedly in terms of rotation on said unlocking shaft and/or being coupled for take-up to said unlocking shaft, said catching piece being seated pivotably on said unlocking shaft and/or being coupled for take-up to said unlocking shaft, and, said tension piece and said catching piece being coupled for take-up with idle travel by means of a mortise-and-tenon guide.

12. The fitting as claimed in claim 1, wherein said first fitting part and said second fitting part in structural terms together form a disk-shaped unit.

13. The fitting as claimed in claim 1, wherein said first fitting part and said second fitting part are in geared connection with one another by means of an, in particular self-locking, eccentric epicyclic gear, said eccentric epicyclic gear bringing about a relative rotation of said first fitting part and of said second fitting part preferably with a superposed wobbling movement.

14.-16. (canceled)

17. A vehicle seat of a motor vehicle, the vehicle seat comprising:
a seat part;
a backrest mounted to said seat part with an adjustable inclination of said backrest relative to said seat part and said backrest being mounted to said seat part for freely pivoting motion relative to said seat part;
a longitudinal adjuster, said seat part being movable forward during a free pivoting motion of the backrest;
a first fitting part fixed with respect to said seat part;
a second fitting part rotatable in relation to said first fitting part, said second fitting part for adjusting the inclination of said backrest relative to said seat part and setting the inclination of said backrest between a plurality of use positions;
a third fitting part fixed with respect to said backrest, said third fitting part being interlockable with said second fitting part and being pivotable about an axis in relation to said second fitting part for a centric pivoting and for the free pivoting of the backrest, said third fitting part being securable in the freely pivoted position of the backrest; and
a pawl for locking said third fitting part in any of the positions of use of the backrest and for securing said third fitting part in the freely pivoted position of the backrest.

18. The vehicle seat as claimed in claim 17, further comprising: a securing ring mounted on and retained on said first fitting part, said pawl securing said third fitting part in the freely pivoted position of the backrest by interaction with said securing ring.

19. The vehicle seat as claimed in claim 18, wherein said pawl, during interaction with said securing ring, engages behind a securing boss of said securing ring with said pawl dropping behind said securing boss in a radially inward direction and when interaction is canceled, said pawl being lifted out in a radially outward direction.

20. The vehicle seat as claimed in claim 18, further comprising: a switching ring mounted for rotation in relation to said securing ring, wherein during a relative rotation of said securing ring and said switching ring, said switching ring cancels interaction between said pawl and said securing ring.

21. The vehicle seat as claimed in claim 20, characterized in that wherein:
said switching ring has a switching cam with a flank extending radially with respect to said axis in the reverse pivoting direction of the backrest to cancel the interaction of said pawl and said securing ring; and
said securing ring or said switching ring rotates in the forward pivoting direction of the backrest, counter to a prestress, with the result that said pawl, which has a switching finger for interaction with the switching ring, passes onto the radially extending flank of the switching cam of the switching ring and, with the progressive pivoting movement of the securing ring or of the switching ring, is lifted out.

22. The vehicle seat as claimed in claim 20, wherein said longitudinal adjuster has a memory device which finds a longitudinal position of the seat part set before the free pivoting and which then activates one of said securing ring and switching ring.

23. The vehicle seat as claimed in claim 20, wherein, when the longitudinal position of the seat set before the free pivoting is not reached, the interaction of the pawl and securing ring can be canceled by the activation of the pawl, of the securing ring or of the switching ring.
